(19) United States
(12) Patent Application Publication
(10) Pub. No.: US 2026/0277188 A1
(43) Pub. Date: Sep. 17, 2026

(54) SYSTEM, DEEP-DRAWING DEVICE AND METHOD FOR FORMING A DEEP-DRAWN OBJECT

(71) Applicant: PRO3DURE MEDICAL GMBH, Iserlohn (DE)

(72) Inventors: Martin KLARE, Dortmund (DE); Frank GISCHER, Iserlohn (DE)

(73) Assignee: PRO3DURE MEDICAL GMBH, Iserlohn (DE)

(21) Appl. No.: 19/165,121

(22) PCT Filed: Mar. 13, 2024
(86) PCT No.: PCT/EP2024/056693

§ 371 Date: Sep. 14, 2025

(30) Foreign Application Priority Data
Mar. 13, 2023 (EP) 23161606.1

(51) Int. Cl. G05B 19/4099

(52) U.S. Cl. CPC G05B 19/4099; G05B 2219/49023

(57) ABSTRACT

The invention relates to a system (1) for forming a deep-drawn object, wherein the system (1) comprises: —a generative manufacturing device (2) configured to generate a three-dimensional (3D) object on a build platform (3) and—a deep-drawing device (4), characterized in that the deep-drawing device (4) comprises a receiving structure (41) configured to receive the build platform (3), particularly the build platform (3) with the 3D object (5) on the build platform (3), such that when the build platform (3) is received by the receiving structure (41), the deep-drawn object can be generated by the deep-drawing device (4) based on the 3D object (5). The invention also relates to a deep-drawing device (4) and a method for forming a deep-drawn object.

The present invention concerns a system for forming a deep-drawn object, a deep-drawing device for forming a deep-drawn object, a method for forming a deep-drawn objected as well as an object formed by such a method.

Deep-drawing processes are shaping processes in which a deep-drawn object is formed based on a 3D object. Typically, in a deep-drawing process, a deep-drawing sheet fixated by a fixation structure is first preheated for improving its plastic deformability, and then drawn over the 3D object, wherein the deep-drawing sheet cools down and turns into a stiffened, deep-drawn object that follows the shape of the 3D object on which is it based on. Problematics in this process commonly arise from the way of how the 3D object is placed or secured with respect to the deep-drawing sheet, such that the resulting deep-drawn objects are of reproducible, high quality.

In particular, in the dental industry, deep-drawing processes are used to form deep-drawn dental splints based on 3D dental models. Typically, in this context, a 3D dental model is manufactured, for example based on a dental impression of a patient, and then placed in a deep-drawing device for forming the dental splint based on the 3D dental model. In the prior art, deep-drawing devices typically comprise a bed of particle granules for placement of the 3D dental model. However, this way of arranging the 3D dental model is prone to inaccuracies of the resulting dental splint due to slight movements of the 3D dental model on the bed of particle granules, once the deep-drawing sheet is drawn over the 3D dental model. Moreover, great care has to be taken to make sure the 3D dental model is arranged even on the bed of particle granules, such that the deep-drawing sheet is drawn correctly over the 3D dental model. Similar drawbacks occur for deep-drawing devices which, other than the particle granules, provide a mechanical fastening of the 3D dental model onto the deep-drawing device, which usually takes a lot of time and is still prone to inaccuracies due to wrong arrangement of the 3D model in the deep-drawing device.

Based on this, it is subject of the present invention to provide a system, a device and a method for forming a deep-drawn object, which allow for faster and more accurate deep-drawing processes compared to the prior art.

This task is solved by a system for forming a deep-drawn object with the features of claim 1, a deep-drawing device according to claim 13 as well as a method for forming a deep-drawn object according to claim 14.

Advantageous embodiments of the invention are given in the corresponding dependent claims and described in the following.

A first aspect of the invention relates to a system for forming a deep-drawn object, wherein the system comprises:
a generative manufacturing device configured to generate a three-dimensional (3D) object on a build platform and
a deep-drawing device,

The deep-drawing device of the system comprises a receiving structure configured to receive the build platform, particularly the build platform with the 3D object on the build platform, such that when the build platform is received by the receiving structure, the deep-drawn object can be formed by the deep-drawing device based on the 3D object.

In particular, the 3D object is a dental model generated on the build platform by the generative manufacturing device in a generative manufacturing process. The 3D object can for example be generated on the build platform by the generative manufacturing device in a generative manufacturing process based on a digital 3D model. Such digital 3D model can be obtained in different ways, which are known to a person skilled in the art. For example, the digital 3D model can be directly scanned by means of a scanner and saved in a readable digital format. Alternatively, if the analog route is chosen, the digital 3D model can be obtained by first obtaining a physical 3D model by means of a casting process, wherein the physical 3D model is then further processed. This further processing includes scanning the physical 3D model to save it in a readable digital format, or directly using it as the deep-drawing object in the deep-drawing device.

The same build platform that is used by the generative manufacturing device for the generative manufacturing process, is used for forming the deep-drawn object using the deep-drawing device. To this end, the deep-drawing device comprises said receiving structure, which serves to receive the build platform such that the deep-drawn object can be formed based on the 3D object.

Preferably, the deep-drawn object is a dental splint. As such, the system according to the first aspect of the invention in particular allows to form a dental splint using the deep-drawing device, based on a dental model that has been generated in the generative manufacturing device.

According to an embodiment of the first aspect of the invention, the deep-drawing device comprises a fixation structure comprising a first and a second circumferential, particularly squared, fixation member for fixing a deep-drawing sheet for forming the deep-drawn object between the first and the second fixation member, such that an inner portion of the deep-drawing sheet is framed by the circumferential fixation members.

In an embodiment of the first aspect of the invention, the deep-drawing device comprises a heating unit configured to heat the deep-drawing sheet fixed by the fixation members to a predefined temperature to promote plastic deformation of the deep-drawing sheet under forces acting on the deep-drawing sheet.

In another embodiment of the first aspect of the invention, when the build platform is received by the receiving structure of the deep-drawing device, the build platform and the fixation members are configured to be moved relative to each other between a first position and a second position, wherein, if the deep-drawing sheet is fixed by the fixation structure and if the 3D object is arranged on the platform, in the first position, a central region enclosed by the circumferential fixation members and thus the deep-drawing sheet fixed by the fixation structure are distant from the 3D object and wherein in the second position, the circumferential fixation members are arranged around the 3D-object, such that the deep-drawing sheet fixed by the circumferential fixation members is drawn over the 3D object, whereby the heated deep-drawing sheet deforms around the 3D object so as to form the deep-drawn object.

In certain embodiments of the first aspect of the invention, the deep-drawing sheet comprises or consists of one of Acrylate, Polymethylmethacrylate, Polystyrol, Polypropylene, Polycarbonate, HDPE, PETG, TPU, PVC, EVA, PE and PAEK or a combination thereof, wherein the one of Acrylate, Polymethylmethacrylate, Polystyrol, Polypropylene, Polycarbonate, HDPE, PETG, TPU, PVC, EVA, PE and PAEK or the combination thereof is heated to a temperature of between 50° C. and 340° C., in particular 140° C. to 200° C., by the heating unit prior to the deep-drawing process. In particular, the deep-drawing sheet can comprise or consist of any suitable material for deep-drawing known to a person skilled in the art. Furthermore, the deep-drawing sheet comprises a thickness of between 0.01 mm to 50 mm depending on the requirements. For example, the system of the invention allows to generate deep-drawn objects for various use cases. Non limiting examples are tooth splints, mouthguards for use in different sports, nightguards or night splints, grinding splints, relaxation splints, bite splints, CMD splints, equilibration splints and/or stabilization splints. Thus, depending on the generated splint, a different thickness of the deep-drawing sheet is necessary to achieve a desired deep-drawn object. For example, a deep-drawing sheet that is used to generate a mouthguard for use in contact sports requires a greater thickness than a night splint.

In certain embodiments of the first aspect of the invention, the fixation structure and in particular the fixation members thereof are configured to fixate a deep-drawing sheet with a different thickness compared to another deep-drawing sheet.

In a further embodiment of the first aspect of the invention, the fixation structure and in particular the fixation members thereof are configured to fixate a plurality of congruent deep-drawing sheets, that comprise or consist of the same or different materials, wherein the heating unit at least partially merges the facing sides of the plurality of deep-drawing sheets by applying heat to the plurality of deep-drawing sheets. This allows, for example, to combine two deep-drawing sheets of different strengths, wherein one deep-drawing sheet comprises or consists of a softer material than the other deep-drawing sheet.

In yet another embodiment of the first aspect of the invention, the receiving structure is configured to receive the build platform in a recess of the receiving structure, such that when the build platform is arranged in the recess of the receiving structure, the 3D object on the build platform protrudes beyond a circumferential top surface of the receiving structure framing an opening of the recess.

In an embodiment of the first aspect of the invention, the receiving structure comprises or consists of an adapter structure. The adapter structure may be placed in or on, particularly fastened to the deep-drawing device and preferably comprises said recess for receiving the build platform, wherein the recess is formed complementary to the build platform. As such, the adapter structure may be used in existing deep-drawing devices to modify them into deep-drawing devices according to the invention, wherein the adapter structure at least partially realizes the receiving structure. In particular, the adapter structure may be placed in a pot structure of a deep-drawing device, wherein the pot structure is configured to receive particle granules for forming a bed of particle granules.

According to another embodiment of the first aspect of the invention, in the second position, the top surface of the receiving structure is in contact with the fixation structure, thereby realizing a stop for the relative movement between the build platform and the fixation structure at the second position.

In an embodiment of the first aspect of the invention, the circumferential top surface of the receiving structure is formed complementary to the circumferential first fixation member of the fixation structure, such that in the second position, the top surface of the receiving structure is circumferentially flush with a contact surface of the first fixation member. In particular, in the second position, the top surface of the receiving structure is circumferentially in contact with a contact surface of the fixation member.

According to an embodiment of the first aspect of the invention, the receiving structure or the first fixation member of the fixation structure comprises at least one first alignment element arranged and configured to be brought into engagement with at least one complementary, second alignment element comprised by the first fixation member of the fixation structure or the receiving structure, wherein in the first position, the first and second alignment elements are distant from each other and wherein in the second position, the first and second alignment elements are in contact with each other.

In another embodiment of the first aspect of the invention, the first alignment element comprises at least one indentation point or -line, particularly a groove, and wherein the second alignment element is shaped complementary to the first alignment element.

According to embodiment of the first aspect of the invention, the first alignment element comprises a groove formed circumferentially on the top surface of the receiving structure and around the opening of its recess, particularly concentrically with the opening, or on the first fixation member, and wherein the second alignment element comprises a circumferential protrusion shaped complementary to the groove, such that the receiving structure and the fixation structure are configured to be pressed against each other by bringing the groove and the protrusion into engagement, particularly such that the engaging first and second alignment elements and the deep-drawing sheet form a gas-tight seal.

According to an embodiment of the first aspect of the invention, the build platform and the receiving structure are formed complementary to each other.

In an embodiment of the first aspect of the invention, the build platform comprises an essentially cylindrical bottom portion configured to be inserted into a mating hollow-cylindrical section of the receiving structure.

In another embodiment of the first aspect of the invention, the build platform comprises an essentially conical top portion that widens away from the bottom portion, wherein the conical top portion of the build platform is mating with a funnel-shaped section of the receiving structure arranged between its top surface and the hollow-cylindrical section.

According to another embodiment of the first aspect of the invention, the system comprises a pivoting device for pivoting the fixation structure and the build platform, particularly the build platform received by the receiving structure, relative to each other by a pivoting motion about a pivot axis defined by the pivoting device.

In yet another embodiment of the first aspect of the invention, the system comprises a linear translational device for moving the fixation structure and the build platform, particularly the build platform received by the receiving structure, relative to each other by a translational motion along a translation axis defined by the linear translational device.

A second aspect of the invention relates to a deep-drawing device, comprising a receiving structure configured to receive a build platform, particularly a build platform with the 3D object on the build platform, such that when the build platform is received by the receiving structure, the deep-drawn object can be generated by the deep-drawing device based on the 3D object.

In particular, the embodiments of the first aspect of the invention that relate to features of the deep-drawing device disclosed therein may be applied to the deep-drawing device according to the second aspect of the invention.

A third aspect of the invention relates to a method for forming a deep-drawn object, wherein a 3D object is generated on a build platform in a generative manufacturing process and the build platform with the 3D object is used in a deep-drawing device to form the deep-drawn object based on the 3D object.

The method according to the third aspect of the invention is particularly advantageous, as the 3D object does not need to be taken off the platform in which it is generated, and subsequently fastened to a structure of the deep-drawing device for the deep-drawing process. This is because one and the same build platform according to the invention is used both in the generative manufacturing process and the deep-drawing process. As a result, the process of generating the 3D object and forming the deep-drawing process is substantially accelerated.

In an embodiment of the third aspect of the invention:
a deep-drawing sheet is fixed between a first and a second circumferential, particularly squared, fixation member of a fixation structure, such that an inner portion of the deep-drawing sheet is framed by the circumferential fixation members,
the deep-drawing sheet is heated by a heating unit to a predefined temperature to promote plastic deformation of the deep-drawing sheet under forces acting on the deep-drawing sheet, and
the build platform and the fixation structure are moved relative to each other between a first position and a second position, wherein in the first position, the deep-drawing sheet fixed by the fixation structure and the 3D object are distant from each other and wherein in the second position, the circumferential fixation members are arranged around the 3D object, such that the deep-drawing sheet fixed by the circumferential fixation members is drawn over the 3D object, whereby the heated deep-drawing sheet deforms around the 3D object so as to form a deep-drawn object, particularly a deep-drawn tooth splint.

In particular, the method according to the third aspect of the invention is executed using the system according to the first aspect of the invention and/or the device according to the second aspect of the invention.

A fourth aspect of the invention relates to a computer program, comprising commands which, if the computer program is executed by a computer, cause the system to execute the method according to the third aspect of the invention.

A fifth aspect of the invention relates to a deep-drawn object, particularly a dental splint, formed by the method according to the third aspect of the invention.

Exemplary embodiments are described below in conjunction with the Figures. The Figures are appended to the claims and are accompanied by text explaining individual features of the shown embodiments and aspects of the present invention. Each individual feature shown in the Figures and/or mentioned in the text of the Figures may be incorporated (also in an isolated fashion) into a claim relating to the system, the device, the method according to the first, second and/or third aspect of the present invention.

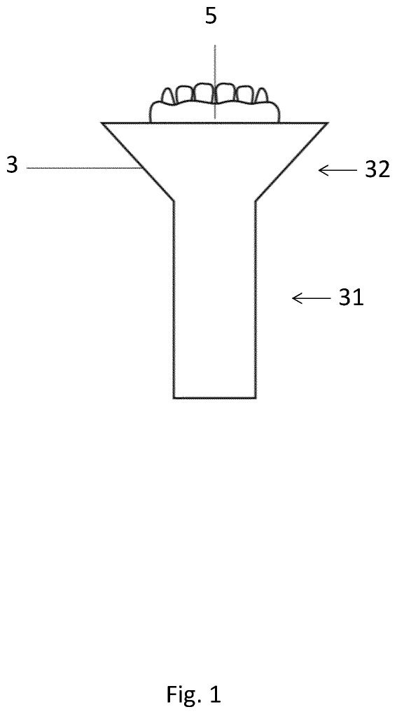

FIG. 1 shows an embodiment of a build platform according to the invention, wherein a 3D object is arranged on the build platform;

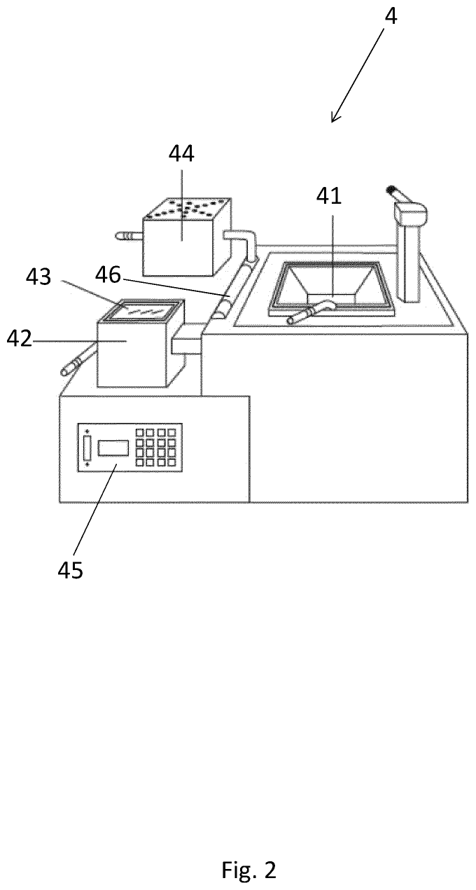

FIG. 2 shows an embodiment of a deep-drawing device according to the second aspect of the invention, wherein a fixation structure for fixating a deep-drawing sheet is arranged in a first position distant from a receiving structure for receiving the build platform with the 3D object;

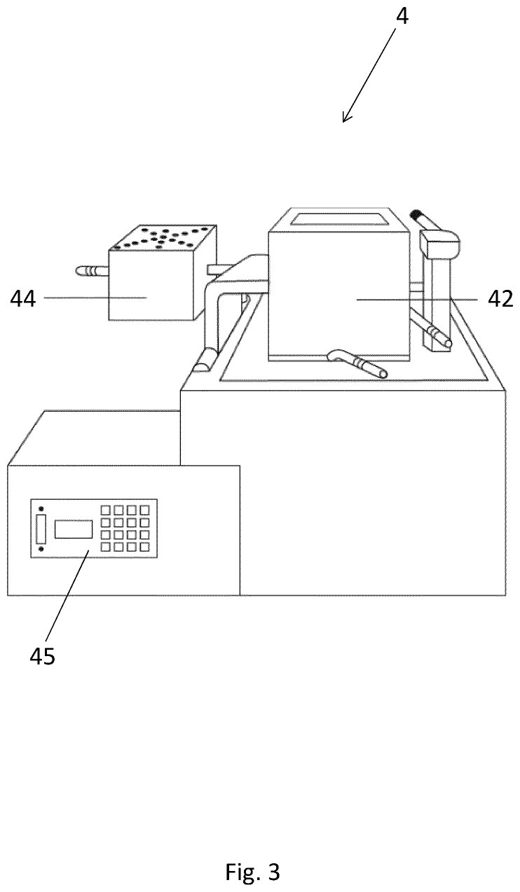

FIG. 3 shows the deep-drawing device of FIG. 2, wherein the fixation structure is pivoted to a second position with respect to the receiving structure, such that a deep-drawn object can be formed based on the 3D object, if the build platform with the 3D object is arranged in the receiving structure;

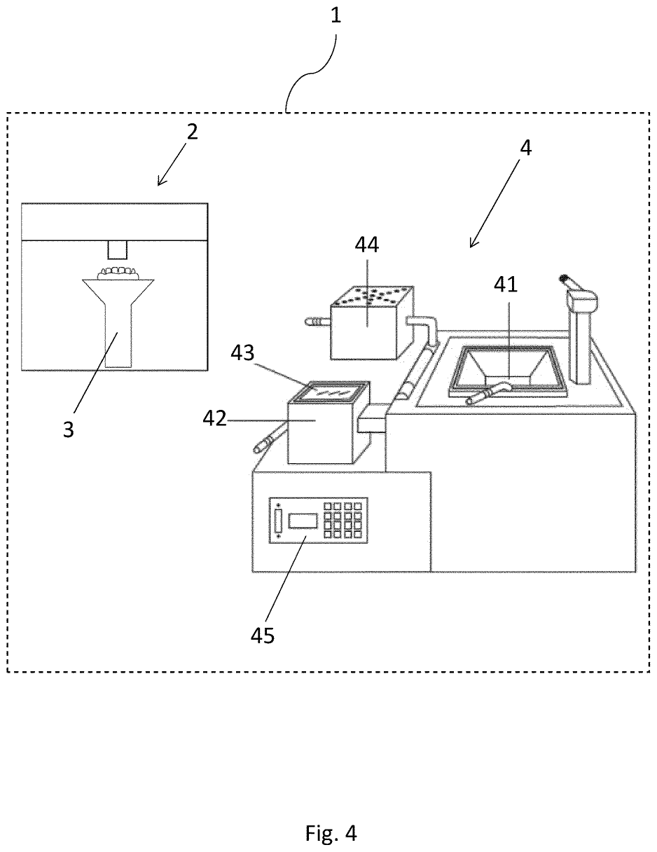

FIG. 4 shows an embodiment of the system according to the first aspect of the invention with the deep drawing device of FIGS. 2 and 3 as well as the build platform of FIG. 1; and

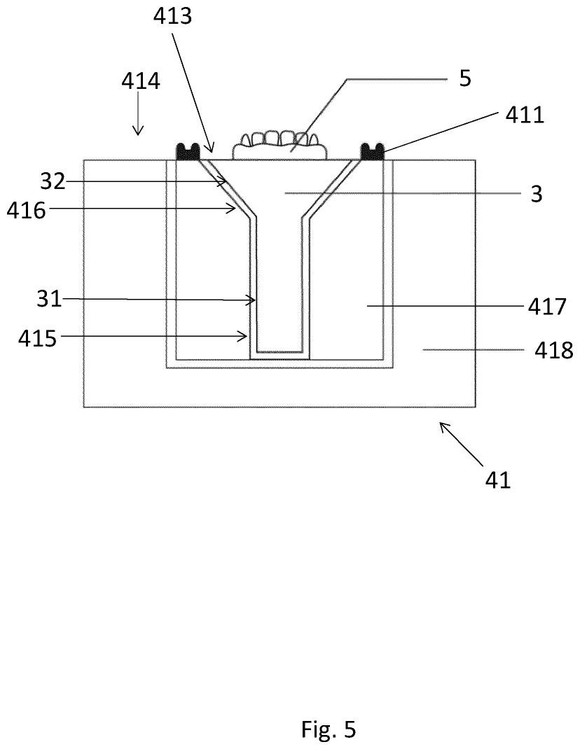

FIG. 5 shows an embodiment of the system, particularly the deep-drawing device according to the invention, wherein the build platform with the 3D object is arranged in an adapter structure of the receiving structure.

FIG. 1 shows an example embodiment of a build platform 3 according to the invention. The build platform 1 is on the one hand used as a basis for a generative manufacturing process in a generative manufacturing device 2, wherein a 3D object 5 is fabricated on the build platform 1. In particular, as shown in FIG. 1, the 3D object 5 may be a dental model or a section of a dental model.

On the other hand, the same build platform 1 with the 3D object formed on it is configured such that it may be used for forming a deep-drawn object based on the 3D object 5 using a deep drawing device 4. In particular, the deep-drawn object is a deep-drawn dental splint formed based on said dental model.

The build platform 3 of the present embodiment comprises an essentially conical top portion 32 that connects to an essentially cylindrical bottom portion 31. The top portion 32 widens away from the bottom portion 32, such that the 3D object 5 can be generated on an even upper surface of the top portion 32.

FIG. 2 shows an embodiment of a deep-drawing device 4 according to the second aspect of the invention. The deep-drawing device 4 of this embodiment comprises a fixation structure 42 for fixating a deep-drawing sheet 43. To this end, the fixation structure 42 preferably comprises a first and a second circumferential, for example squared, fixation member for fixing the deep-drawing sheet 43 between the two fixation members, such that an inner portion of the deep drawing sheet 43 is framed by the circumferential fixation members. Particularly, the two fixation members may be pressed together with a predefined force, such that the deep-drawing sheet 43 is circumferentially pressed together from two sides by the fixation members. The force with which the deep-drawing sheet 43 is pressed together may be set depending on the respective deep-drawing process.

Moreover, the deep-drawing device 4 comprises a heating unit 44 configured to heat the deep-drawing sheet 43 fixed by the fixation structure 42 to a predefined temperature. As such, a plastic deformation of the deep-drawing sheet 43 under forces acting on the deep-drawing sheet 43 can be promoted. For example, the deep-drawing sheet 43 comprises or consists of acrylate, polymethylmethacrylate, polystyrol, polypropylene, polycarbonate, high density polyethylene (HDPE), polyethylene terephthalate glycol (PETG), thermoplastic polyurethane (TPU), polyvinyl chloride (PVC), ethylene-vinylacetat-copolymere (EVAC, EVA), polyethylene (PE) and polyaryletherketone (PAEK) or a combination thereof, wherein the material or the combination of materials is heated to a temperature of between 50° C. and 340° C., in particular 140° C. to 200° C., before the deep-drawing process.

To perform a deep-drawing process, the heated deep-drawing sheet 43 fixed by the fixation members of the fixation structure 42 is drawn over the 3D object 5 on the build platform 3, which is secured to the deep-drawing device 4 by its receiving structure 41. The build platform 3 arranged in the receiving structure 41 is further depicted in FIG. 5. To draw the deep-drawing sheet 43 over the 3D object 5, the deep-drawing device 4 according to the present embodiment comprises a pivoting device 46 for pivoting the deep-drawing sheet 43 fixed by the fixation structure 42 over the 3D object 5. FIG. 2 illustrates a first position, where the fixation structure 42 with the deep-drawing sheet 43 are distant from the receiving structure 41 and the 3D object 5. In particular, in this first position, the deep-drawing sheet 43 may be fastened to the fixation structure 42 before a deep-drawing process.

As can further be seen in FIG. 2, the deep-drawing device 4 comprises a user interface 45, which may particularly be used by a user to set the temperature to which the deep-drawing sheet 43 is heated or to set the force with which the deep-drawing sheet 43 is pressed together by the fixation members of the fixation structure 42.

FIG. 3 shows the deep-drawing device 4 according to the embodiment of FIG. 2, wherein the fixation structure 42 and the deep-drawing sheet 43 fixed by the fixation structure 42 are arranged in a second position with respect to the build platform 3 and the 3D object 5 on the build platform 3. In this second position, the circumferential fixation members of the fixation structure 42 are arranged around the 3D-object 5, such that the deep-drawing sheet 43 fixed by the circumferential fixation members is drawn over the 3D object 5, whereby the heated deep-drawing sheet 43 deforms around the 3D object 5 so as to form the deep-drawn object. Subsequently, upon contact with the colder 3D object, the deep-drawn object cools down toward room temperature, wherein the material stiffens and maintains its shape. The fixation structure 42 may then be pivoted back to or towards the first position, where the deep-drawn object can be taken out.

FIG. 4 shows an embodiment of a system 1 according to the first aspect of the invention. The system comprises the deep-drawing device 4 presented in FIGS. 2 and 3 as well as a generative manufacturing device 2 configured to in a generative manufacturing process, generate the 3D object 5 on the build platform 3 shown in FIG. 1. For example, the generative manufacturing process may include: vat photopolymerization, material jetting, binder jetting, powder bed fusion, material extrusion, directed energy deposition, and/or sheet lamination.

Upon generating the 3D object 5 by the generative manufacturing device 2, the build platform 3 may be taken out of the generative manufacturing device 2 and transferred to the deep-drawing device 4, where the build platform 3 is fastened to the receiving structure 41 of the deep-drawing device 4 for deep-drawing a deep-drawn object based on the 3D object 5. As such, the process of forming a deep-drawn object based on a 3D object 5 is substantially simplified and speeded up compared to the prior art, since the 3D object is generated on the same platform—the build platform 3—which is used for the deep-drawing process. In contrast, in the prior art, the 3D object is typically fabricated in one device to then be transferred as such, i.e. without a platform, and placed in a bed of particle granule of a deep-drawing device 4. At the same time, the receiving structure 41 allows for a secure fastening of the build platform 3 to the deep-drawing device 4, such that the 3D object 5 on the build platform 3 is kept at a fixed position and cannot move, as the deep-drawing sheet 43 is deep-drawn over the 3D object 5 to form the deep-drawn object. As a consequence, the quality of the deep-drawn object is improved to the prior art, where the 3D object 5 is typically placed without further mechanical fixation on said bed of particle granule, such that the 3D object 5 might move once the deep-drawing sheet 43 is deep-drawn over the 3D object 5, which worsens the quality of the deep-drawn object.

Fabrication of the 3D object and subsequent deep-drawing in one system has further advantages. For example, when 3D objects are fabricated in a respective device and then transferred to a device for forming a deep-drawing object, the 3D object often possesses little imperfections or distortions that are due to the removal or transferring process. These must then be removed or corrected, which can involve a great deal of manual labor, which is ultimately time consuming. The system of the invention thus eliminates these limitations by combining generating a 3D object and deep-drawing a deep-drawing object based on said 3D object into one system.

FIG. 5 highlights the arrangement of the build platform 3 with respect to the receiving structure 41 of the system 1, particularly the deep-drawing device 4, according to an embodiment of the invention. The receiving structure 41 is shown in a cut representation, which illustrates a pot structure 418 and an adapter structure 417 arranged in the pot structure 418.

Deep-drawing devices 4 typically comprise pot structures 418 as the one shown in FIG. 5, wherein the pot structure 418 in the prior art is filled with said particle granules, such that the 3D object 5 can be placed on top of a bed of particle granules formed thereby. In contrast, according to the present embodiment, the receiving structure 41 comprises an adapter structure 417 which is inserted into the pot structure 418.

In particular, the adapter structure 417 is formed complementary to the pot structure 418. For example, the adapter structure 417 may comprise a squared cross-section, such that it may be inserted flush into a pot structure 418 with a mating, squared cross-section. The adapter structure 417 may thus just be placed in the pot structure 418, with no further mutual fastening means.

Alternatively, the adapter structure 417 may be fastened to the pot structure 418, for example by means of a clamp or snap-in connection. This may particularly be the case if the adapter structure 417 and the pot structure 418 are not shaped complementary to each other.

The adapter structure 417 shown in FIG. 5 comprises a central recess 413 for receiving the build platform 3 therein. As can further be seen here, the recess 413 of the receiving structure 41 is formed complementary to the build platform 3: the cylindrical bottom portion 31 of the build platform 3 is mating with a hollow-cylindrical section 415 of the receiving structure 41 and the conical top portion 32 of the build platform 3 is mating with a funnel-shaped section 416 of the receiving structure 41. As such, the build platform 3 can be securely arranged within the receiving structure 41 just by means of their complementary shapes, without further fastening means. In particular, the conical top portion 32 of the build platform 3 and the corresponding funnel-shaped section 416 cause an advantageous centering and stabilization of the build platform 3 in the recess of the receiving structure 41.

Optionally, the build platform 3 may be fastened to the adapter structure 417, for example by means of a clamp or snap-in connection. Preferably, the connection between the build platform 3 and the adapter structure 417 is repeatedly releasable, such that the build platform 3 can be repeatedly fastened to and removed from the adapter structure 417.

The adapter structure 417 may particularly be used to upgrade existing deep-drawing devices 4 comprising pot structures 418, particularly for receiving said particle granule, such that the build platform 3 can be received by the receiving structure 41 according to the invention.

Alternatively, the pot structure 418 of the receiving structure 41 may itself be shaped complementary to the build platform 3, such that the build platform 3 can be arranged flush in a recess formed by the pot structure 418, wherein no additional adapter structure 417 is necessary. In this case, the build platform 3 may be configured to be fastened to the pot structure 418, and the statements regarding the interplay between the build platform 3 and the adapter structure 417 apply mutatis mutandis for the pot structure 418 instead of the adapter structure 417.

Moreover, as can be seen in FIG. 5, the receiving structure 41 and the build platform 3 are configured such that when the build platform 3 is arranged in the recess 413 of the receiving structure 41, the 3D object 5 on the platform protrudes beyond a circumferential top surface 414 of the receiving structure 41 framing the opening of the recess 413. As such, the arrangement of the build platform 3 within the receiving structure 41 allows for deep-drawing processes by drawing a deep-drawing sheet 43 over the 3D object 5.

For a deep-drawing process, the fixation structure 42 with the deep-drawing sheet 43 is moved from the first position, depicted in FIG. 2, to the second position, depicted in FIG. 3, with respect to the receiving structure 41. At the second position, the top surface 414 of the receiving structure 41 is in contact with the fixation structure 42 and thereby realizes a stop for the relative movement between the build platform 3 and the fixation structure 42 at the second position.

In particular, the circumferential top surface 414 of the receiving structure 41 is formed complementary to the circumferential fixation members of the fixation structure 42, such that in the second position, the receiving structure 41 and the fixation members of the fixation structure 42 circumferentially enclose the 3D object 5, wherein the deep-drawing sheet 43 is drawn over the 3D object 5.

FIG. 5 also shows a first alignment element 411 by means of a groove of the fixation structure 42 arranged and configured to be brought into engagement with a complementary second alignment element 412 of the fixation structure 42. In this example embodiment, the groove follows a square-shape around the 3D-object 5, such that the second alignment element 412 of the fixation structure 42 is also square-shaped. The second alignment element 412 may comprise a circumferential protrusion for engagement with the groove forming the first alignment element 411 in the second position. As such, a precise positioning of the deep-drawing sheet 43 by means of the fixation structure 42 with respect to the 3D object 5 received by the receiving structure 41 is achieved.

Optionally, the deep-drawing device 4 may comprise a pump for removing air below the deep-drawing sheet 43 once the first and second alignment elements 411,412 are in contact, such that a seal is formed. As such, the deep-drawing sheet may be i) drawn over the 3D object 5 fixated by the fixation structure 42 as a consequence of the 3D object 5 protruding beyond the top surface 414, particularly beyond the first alignment means 411 and ii) pulled downwards towards the bottom portion 415 of the build platform 3 as a consequence of a pressure gradient between the side of the deep-drawing sheet facing the 3D-object 5 and an opposite side facing away from the 3D object 5. This measure further improves the quality of the deep-drawn object formed hereby.

### LIST OF REFERENCE SIGNS

System 1
Generative manufacturing device 2
Build platform 3
Deep-drawing device 4
Three-dimensional object 5
Bottom portion 31
Top portion 32
Receiving structure 41
Fixation structure 42
Deep-drawing sheet 43
Heating unit 44
User interface 45
Pivoting device 46
First alignment element 411
Second alignment element 412
Recess 413
Top surface 414
Hollow-cylindrical section 415
Funnel-shaped section 416
Adapter structure 417
Pot structure 418

1. A system (1) for forming a deep-drawn object, wherein the system (1) comprises:
a generative manufacturing device (2) configured to generate a three-dimensional (3D) object (5) on a build platform (3) and
a deep-drawing device (4),
characterized in that the deep-drawing device (4) comprises a receiving structure (41) configured to receive the build platform (3), particularly the build platform (3) with the 3D object (5) on the build platform (3), such that when the build platform (3) is received by the receiving structure (41), the deep-drawn object can be formed by the deep-drawing device (4) based on the 3D object (5).

2. The system (1) according to claim 1, wherein the deep-drawing device (4) comprises a fixation structure (42) comprising a first and a second circumferential, particularly squared, fixation member for fixing a deep-drawing sheet (43) for forming the deep-drawn object between the first and the second fixation member, such that an inner portion of the deep-drawing sheet (43) is framed by the circumferential fixation members.

3. The system (1) according to claim 2, wherein the deep-drawing device (4) comprises a heating unit (44) configured to heat the deep-drawing sheet (43) fixed by the fixation members to a predefined temperature to promote plastic deformation of the deep-drawing sheet (43) under forces acting on the deep-drawing sheet (43).

4. The system (1) according to claim 2, wherein, when the build platform (3) is received by the receiving structure (41) of the deep-drawing device (4), the build platform (3) and the fixation members are configured to be moved relative to each other between a first position and a second position, wherein, if the deep-drawing sheet (43) is fixed by the fixation structure (42) and if the 3D object (5) is arranged on the build platform (3), in the first position, a central region enclosed by the circumferential fixation members and thus the deep-drawing sheet (43) fixed by the fixation structure (42) are distant from the 3D object (5) and wherein in the second position, the circumferential fixation members are arranged around the 3D-object, such that the deep-drawing sheet (43) fixed by the circumferential fixation members is drawn over the 3D object (5), whereby the heated deep-drawing sheet (43) deforms around the 3D object (5) so as to form the deep-drawn object.

5. The system (1) according to claim 1, wherein the receiving structure (5) is configured to receive the build platform (3) in a recess (413) of the receiving structure (41), such that when the build platform (3) is arranged in the recess (413) of the receiving structure (41), the 3D object (5) on the build platform (3) protrudes beyond a circumferential top surface (414) of the receiving structure (41) framing an opening of the recess (413).

6. The system (1) according to claim 5, wherein in the second position, the top surface (414) of the receiving structure (41) is in contact with the fixation structure (42), thereby realizing a stop for the relative movement between the build platform (3) and the fixation structure (42) at the second position.

7. The system (1) according to claim 5, wherein the circumferential top surface (414) of the receiving structure (41) is formed complementary to the circumferential first fixation member of the fixation structure (42), such that in the second position, the top surface (414) of the receiving structure (41) is circumferentially flush with a contact surface of the first fixation member.

8. The system (1) according to claim 5, wherein the receiving structure (41) or the first fixation member of the fixation structure (42) comprises at least one first alignment element (411) arranged and configured to be brought into engagement with at least one complementary, second alignment element (412) comprised by the first fixation member of the fixation structure (42) or the receiving structure (41), wherein in the first position, the first and second alignment elements (411,412) are distant from each other and wherein in the second position, the first and second alignment elements (411,412) are in contact with each other.

9. The system (1) according to claim 8, wherein the first alignment element (411) comprises a groove formed circumferentially:
on the top surface (414) of the receiving structure (41) and around the opening of its recess (413), particularly concentrically with the recess (413), or
on the first fixation member,
and wherein the second alignment element (412) comprises a circumferential protrusion shaped complementary to the groove, such that the receiving structure (41) and the fixation structure (42) are configured to be pressed against each other by bringing the groove and the protrusion into engagement, particularly such that the engaging first and second alignment elements (411,412) and the deep-drawing sheet (43) form a gas-tight seal.

10. The system (1) according to claim 5, wherein the build platform (3) and the receiving structure (41) are formed complementary to each other.

11. The system (1) according to claim 5, wherein the build platform (3) comprises an essentially cylindrical bottom portion (31) configured to be inserted into a mating hollow-cylindrical section (415) of the receiving structure (41).

12. The system (1) according to claim 11, wherein the build platform (3) comprises an essentially conical top portion (32) that widens away from the bottom portion (31), wherein the conical top portion (32) of the build platform (3) is mating with a funnel-shaped section (416) of the receiving structure (41) arranged between its top surface (414) and the hollow-cylindrical section (415).

13. A deep-drawing device (4) for forming a deep-drawn object, characterized in that the deep-drawing device (4) comprises a receiving structure (41) configured to receive a build platform (3), particularly a build platform (3) with a 3D object (5) on the build platform (3), such that when the build platform (3) is received by the receiving structure (41), the deep-drawn object can be generated by the deep-drawing device (4) based on the 3D object (5).

14. A method for forming a deep-drawn object, wherein a 3D object (5) is generated on a build platform (3) in a generative manufacturing process and the build platform (3) with the 3D object (5) is used in a deep-drawing device (4) to form the deep-drawn object based on the 3D object (5).

15. The method for forming a deep-drawn object according to claim 14, wherein:
a deep-drawing sheet (43) is fixed between a first and a second circumferential, particularly squared, fixation member of a fixation structure (42), such that an inner portion of the deep-drawing sheet (43) is framed by the circumferential fixation members,
the deep-drawing sheet (43) is heated by a heating unit (44) to a predefined temperature to promote plastic deformation of the deep-drawing sheet (43) under forces acting on the deep-drawing sheet (43), and
the build platform (3) and the fixation structure (42) are moved relative to each other between a first position and a second position, wherein in the first position, the deep-drawing sheet (43) fixed by the fixation structure (42) and the 3D object (5) are distant from each other and wherein in the second position, the circumferential fixation members are arranged around the 3D object (5), such that the deep-drawing sheet (43) fixed by the circumferential fixation members is drawn over the 3D object (5), whereby the heated deep-drawing sheet (43) deforms around the 3D object (5) so as to form a deep-drawn object, particularly a deep-drawn tooth splint.
